(19) United States
(12) Patent Application Publication
(10) Pub. No.: US 2014/0039989 A1
(43) Pub. Date: Feb. 6, 2014

(54) RV GOLF ASSOCIATION

(71) Applicant: RV Golf Club, Las Vegas, NV (US)

(72) Inventor: James J. Vernes, Las Vegas, NV (US)

(73) Assignee: RV Golf Club, Las Vegas, NV (US)

(21) Appl. No.: 13/956,075

(22) Filed: Jul. 31, 2013

Related U.S. Application Data
(60) Provisional application No. 61/678,054, filed on Jul. 31, 2012.

(51) Int. Cl. G06Q 30/02

(52) U.S. Cl. CPC G06Q 30/0207
USPC 705/14.1

(57) ABSTRACT

A system and method facilitates member registration for an RV golf association via a computing device. A membership home page is generated on a computing device. At least one link is provided from the membership home page associated with at least one user type. At least one link to an application type associated with the selected user type is provided. Registration data and payment, if required, is received from the user. The user may be prompted to register for an email club that delivers relevant updates to registered users. A search feature that allows users to conduct searches for detailed information regarding the properties available through the RV golf association may be provided.

### RELATED APPLICATIONS

The present application claims priority to U.S. provisional application No. 61/678,054, filed Jul. 31, 2012, the disclosure of which is incorporated by reference.

### BACKGROUND

2. Field of the Invention

The present invention generally concerns discount association membership. More particularly, the present invention relates to an application that facilitates the offering of deals and discounts to recreational vehicle (RV) owners and consumers by property owners and product and service providers.

### BACKGROUND OF THE INVENTION

A recreational vehicle (RV), having one or more living quarters and amenities, has become a viable and convenient option for temporary or permanent housing, office space, or use during vacations or other leisurely activities. RVs are typically seen in designated RV parks, campsites, trailer parks, or the like. Unlike traditional vehicles, RVs include various components (e.g., converters, generators, tanks, hookups for water, sewage, and electricity, etc.) and subsequently require a much larger area for parking and storage. Thus, there is a need for an application and relationship that assists RVs and their owners to acquire various discounts and deals and necessities associated with RV use.

### SUMMARY OF THE CLAIMED INVENTION

Embodiments of the present invention provide an RV golf association application for assisting RV owners acquire necessities of RV use and/or other perks, discounts, and deals.

The RV golf association application facilitates relationships between a plurality of users communicatively coupled in a network via computing devices, namely, a property owner (e.g., golf course or resort) and a RV owner. The property owner may offer products, services, amenities, and/or activities to the RV owner at reduced or discounted prices.

To become a member of the RV golf association network/user of the RV golf association application, a property owner or RV owner may register and be required to input or provide, via a computing device, registration data. A property owner for example may be requested to provide information about available amenities, fees, and what discounts or deals it is willing to offer. A RV owner, for example, may be requested to provide pertinent personal information as well as demographic information, geographic location, interests, hobbies, and preferences that may be used to generate a profile of the RV owner. A RV owner profile may be used to tailor offers and deals offered by registered property owners and product and service providers. Such offers and deals may be pushed to RV owners via the RV golf association application. Once a RV owner has registered, the RV owner may automatically be provided with access and redeem via the RV golf association application various deals, discounts, and offers provided by property owners. The RV golf association application may include an interactive map that displays all participating property owners and product and/or service providers.

In one embodiment, the RV golf association application may include product and/service providers, such as insurance providers, travel and tourism entities, and telecommunication and wireless services, that provide deals and discounts for their associated offerings, such as insurance programs for the RV, overseas RV caravans, and vacation packages. A property owner or RV owner may or may not pay a membership, registration, access, or other fee to be a member of the RV golf association network.

In another embodiment, the RV golf association application may include a loyalty program that tracks RV owner activities and purchases and provides rewards. In one embodiment, a RV owner may receive a reward (e.g., additional months of free membership) for referring new members to the RV golf association network.

### BRIEF DESCRIPTION OF THE FIGURES

FIG. 1 illustrates a method for an RV golf association registration.

FIG. 2 illustrates an exemplary interface for a home page.

FIG. 3 illustrates an exemplary interface for a membership page.

FIG. 4A illustrates an exemplary interface for a member registration page.

FIG. 4B illustrates an exemplary interface for an annual membership registration page.

FIG. 4C illustrates an exemplary interface for a lifetime membership registration page.

FIG. 5 illustrates an exemplary interface for an email club registration page.

FIG. 6A illustrates an exemplary interface for an interactive property map.

FIG. 6B illustrates an exemplary interface for a detailed interactive property map.

FIG. 7 illustrates an exemplary interface for a property owner page.

FIG. 8A illustrates a first screen of an exemplary interface for a property owner registration page.

FIG. 8B illustrates a second screen of an exemplary interface for a property owner registration page.

FIG. 8C illustrates a third screen of an exemplary interface for a property owner registration page.

FIG. 9 illustrates a computing system that may be used to implement the method of FIG. 1.

### DETAILED DESCRIPTION

Embodiments of the present invention provide an RV golf association application for assisting RV owners acquire necessities of RV use and/or other perks, discounts, and deals. Persons of ordinary skill in the art will realize that the following description of the presently invention is illustrative only and not in any way limiting. Other embodiments of the invention will readily suggest themselves to such skilled persons.

The RV golf association application facilitates relationships between a plurality of users communicatively coupled in a network via computing devices, namely, a property owner (e.g., golf course or resort) and a RV owner. The property owner may offer products, services, amenities, and/or activities to the RV owner at reduced or discounted prices.

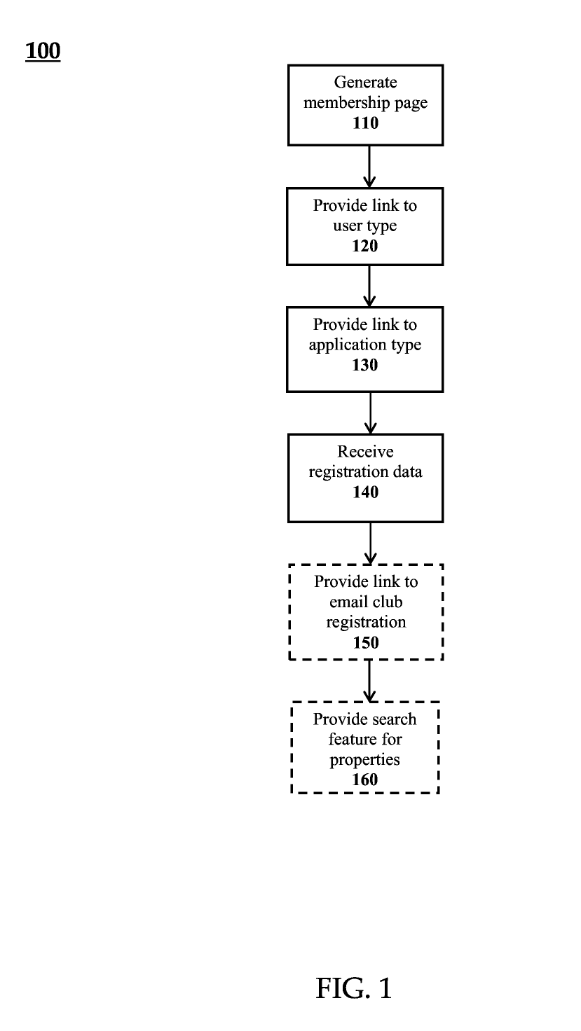

FIG. 1 illustrates a method for an RV golf association registration. The steps identified in FIG. 1 (and the order thereof) are exemplary and may include various alternatives, equivalents, or derivations thereof including but not limited to the order of execution of the same. The steps of the method of FIG. 1 (and its various alternatives) may be embodied in hardware or software including a non-transitory computer-readable storage medium (e.g., an optical disc or memory card) having instructions executable by a processor of a computing device.

An RV golf association application may be implemented by one or more processors that execute instructions stored in non-transitory memory mediums. The executed code may result in the processor(s) generating one or more graphical interfaces.

Referring now to FIG. 1, the method 100 is activated by generating a membership home page on a computing device, such as a personal computer or mobile device, at step 110.

At step 120, at least one link is provided from the membership home page associated with at least one user type, which may be labeled “Click Here to Get Started” or similar. At step 130, at least one link to at least one application type associated with the chosen user type is provided. Using these links, the user may select a membership application type. Membership application types may include, for example, RV owner or property owner, and may include terms of membership (i.e., annual or lifetime).

At step 140, registration data may be received from the user. The registration data may include, for example, user demographic information, user preferences, user contact information, RV information, property information, log-in information (i.e., user name and password), and other relevant information requested by an RV golf association administrator. The type of registration data required may vary depending on the application type. Also at step 140, the user may be prompted to enter payment information, if required, by way of credit or debit card.

At step 150, the user may be prompted to register for an email club, which is an electronic communication service that delivers to the user relevant updates about, for example, events, discounts, VIP tickets, promotional events, preferred pricing, and travel benefits. Registration for the email club may be optional or required to join the RV golf association.

At step 160, a search feature may be offered to users to conduct searches for detailed information regarding the properties available through the RV golf association.

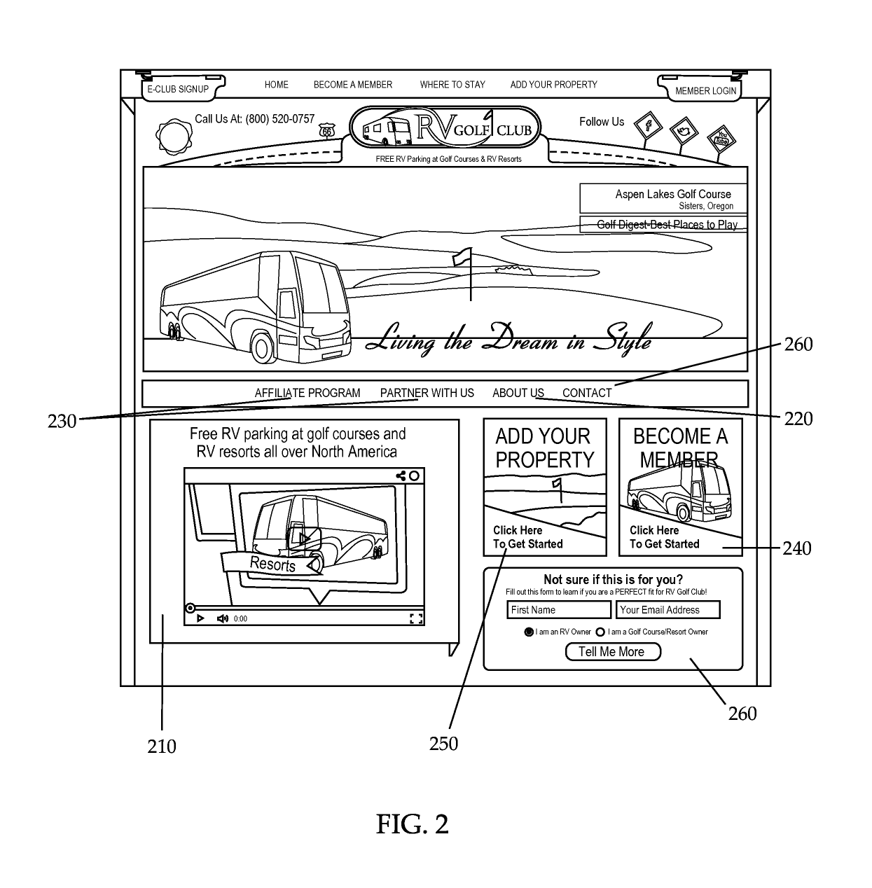

FIGS. 2-9C illustrate exemplary interfaces for an RV golf association application.

Referring now to FIG. 2, illustrating an exemplary interface for a home page of an RV golf association application, an RV golf association administrator may post information related to an RV golf association application. Information may include, for example, promotional information and advertising 210, information about the RV golf association 220, information regarding affiliate and/or partner programs 230, a link for property owners to begin the registration process 240, a link for RV owners to begin the registration process for membership 240, and links to contact the RV golf association administrator for further information 260.

In one embodiment, the RV golf association application may include product and/service providers, such as insurance providers, travel and tourism entities, and telecommunication and wireless services, that provide deals and discounts for their associated offerings, such as insurance programs for the RV, overseas RV caravans, and vacation packages.

In another embodiment, the RV golf association application may include a loyalty program that tracks RV owner activities and purchases and provides rewards. In one embodiment, a RV owner may receive a reward (e.g., additional months of free membership) for referring new members to the RV golf association network.

In another embodiment, the RV golf association application may be integrated with or registered with one or more social networking outlets such as Facebook®.

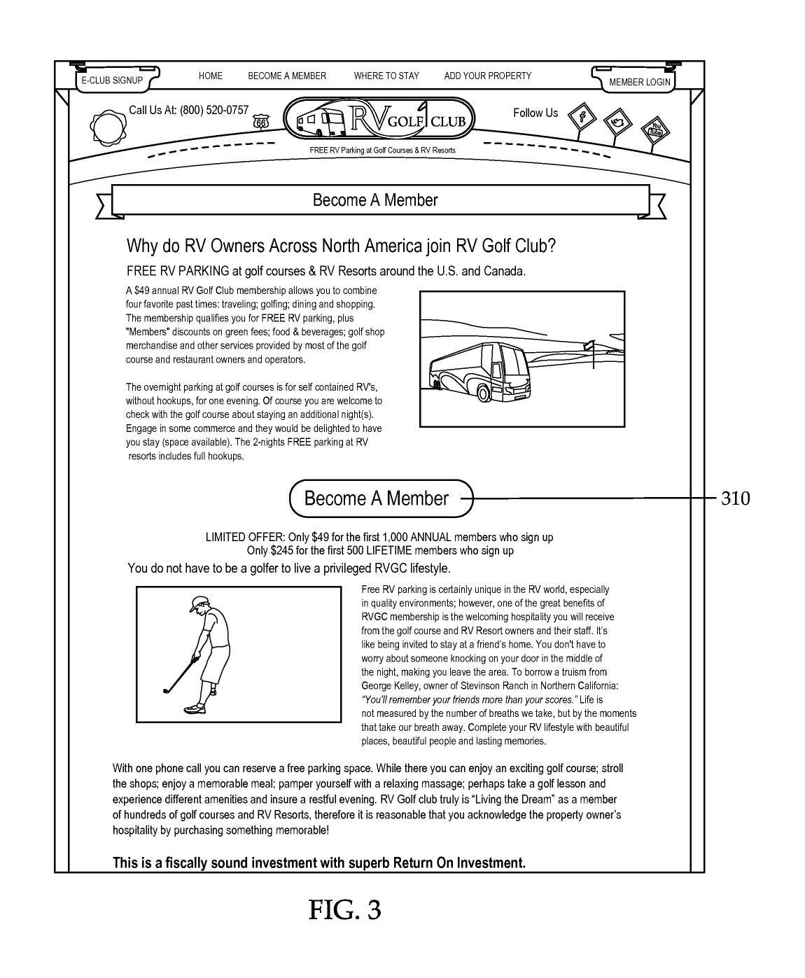

Referring now to FIG. 3, illustrating an exemplary interface for a membership page, after the user (i.e., an RV owner) clicks link 240 to begin the registration process, the user may be directed to a membership page. The membership page may include information regarding, for example, the benefits of membership with an RV golf association, pricing, membership types, and testimonials from previous customers. The user may click on “Become a Member” link 310 to begin the registration process.

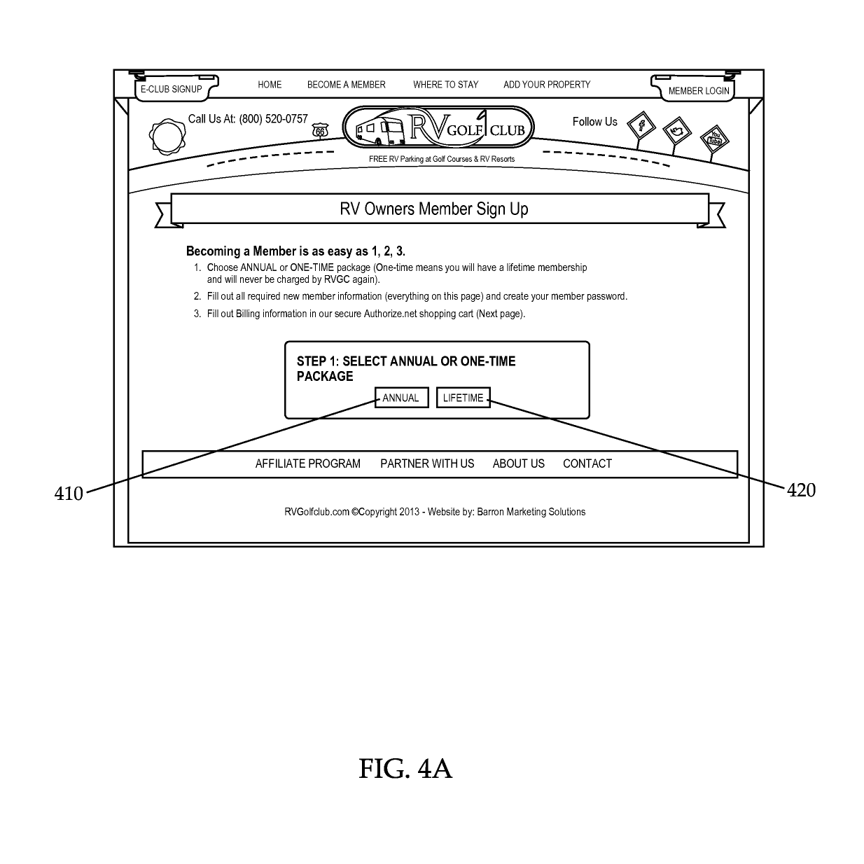

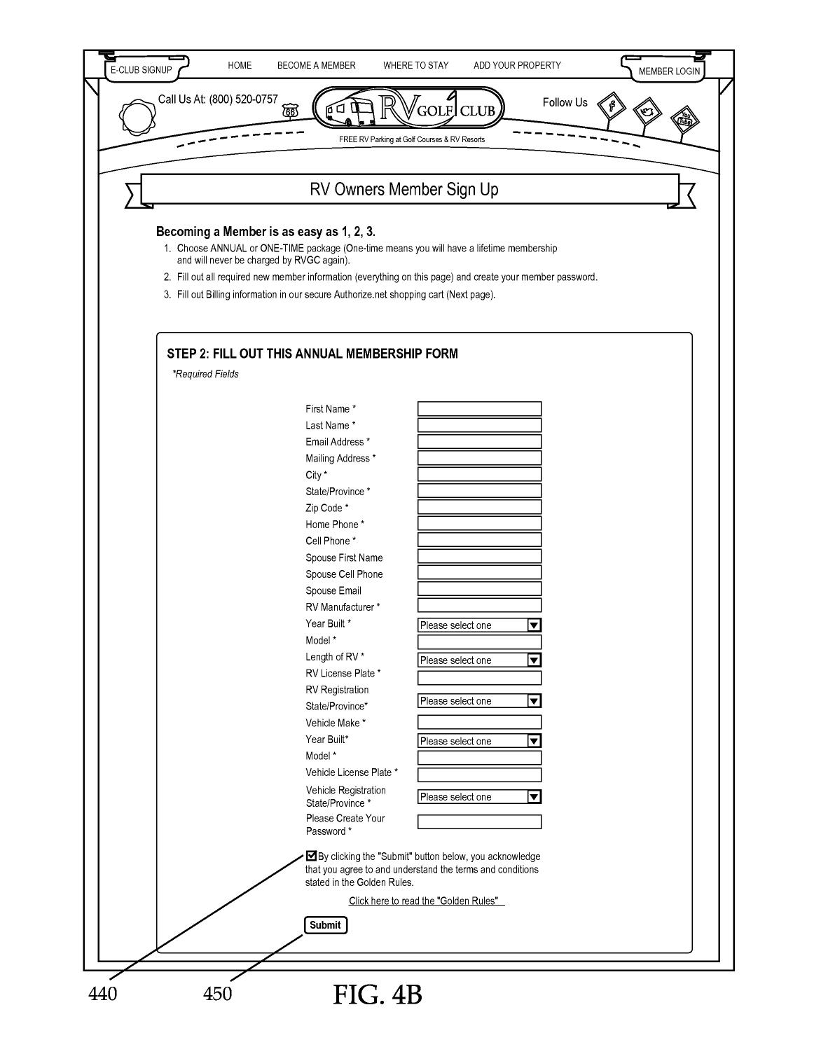

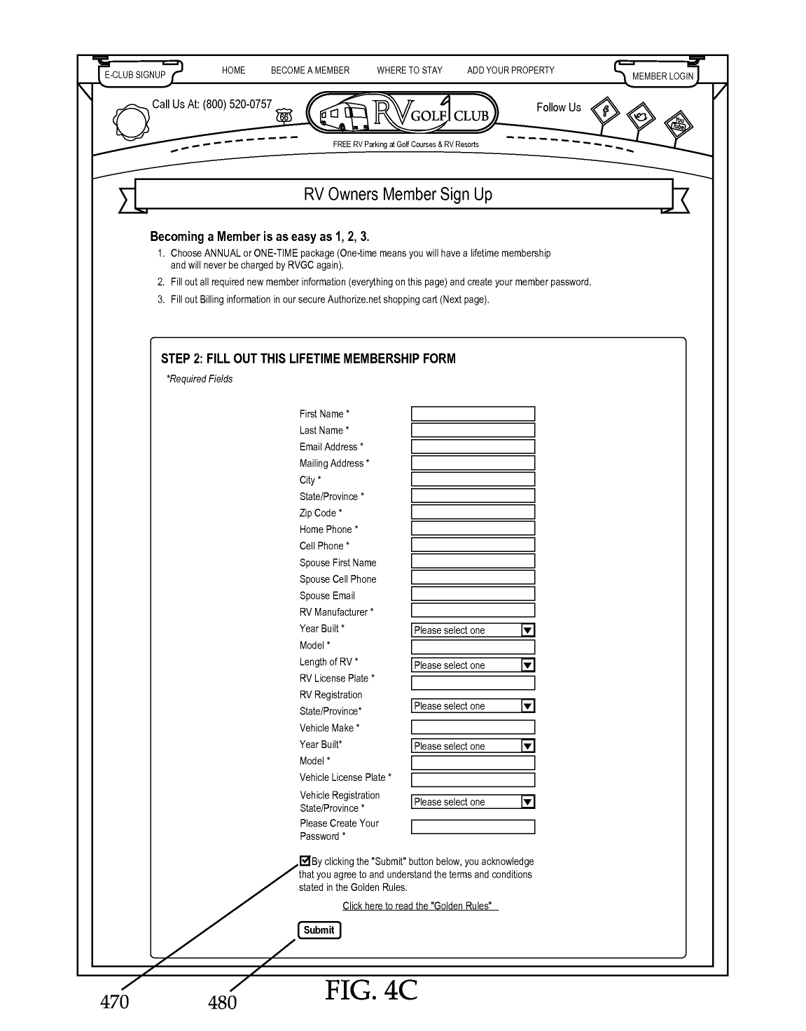

Referring now to FIG. 4A, illustrating an exemplary interface for a member registration page, the user may be presented with different membership types. For example, the RV golf association administrator may allow the user to select a renewable annual membership for an annual fee, or a lifetime membership for a one-time fee. In the exemplary interface, the user may select “Annual” package 410 or “Lifetime” package 420.

Referring now to FIG. 4B, illustrating an exemplary interface for an annual membership registration page, the user may provide registration data 430. Registration data may include, for example, user demographic information, user preferences, user contact information, RV information, log-in information (i.e., user name and password), and other relevant information requested by an RV golf association administrator. The user may be required to agree to terms and conditions of membership with the RV golf association at box 440. The user may submit the registration data 430 by clicking “Submit” button 450. The user may then be prompted to enter payment information for the registration (not shown). Payment information may include, for example, credit or debit card information. The payment information may be processed via a third party payment processor.

Referring now to FIG. 4C, illustrating an exemplary interface for a lifetime membership registration page, the user may provide registration data 460. Registration data may include, for example, user demographic information, user preferences, user contact information, RV information, log-in information (i.e., user name and password), and other relevant information requested by an RV golf association administrator. The user may be required to agree to terms and conditions of membership with the RV golf association at box 440. The user may submit the registration data 470 by clicking “Submit” button 480. The user may then be prompted to enter payment information for the registration (not shown). Payment information may include, for example, credit or debit card information. The payment information may be processed via a third party payment processor.

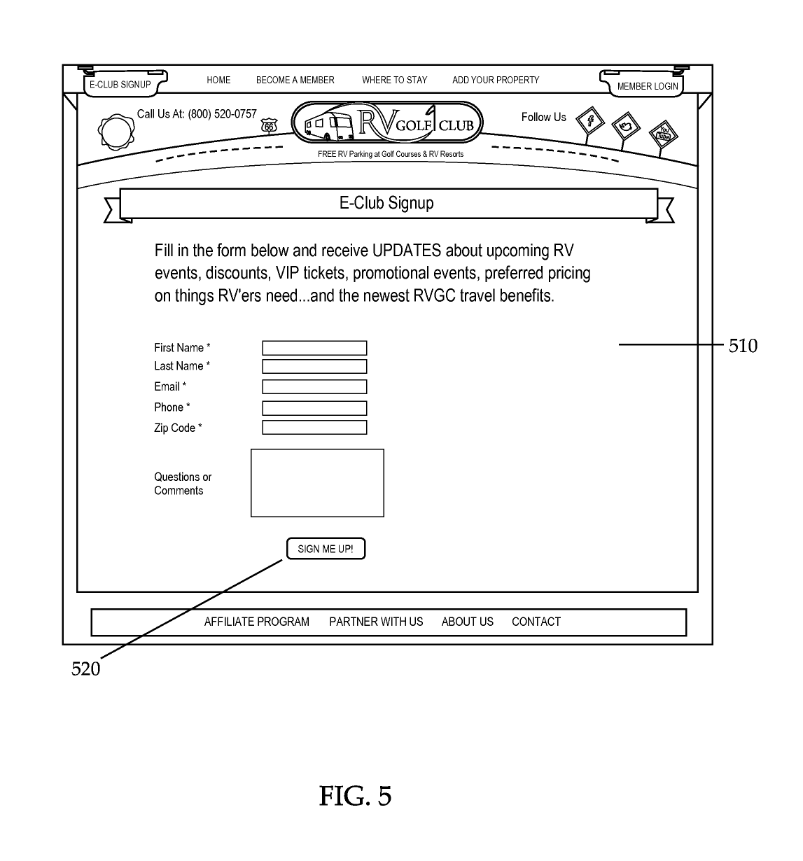

Referring now to FIG. 5, illustrating an exemplary interface for an email club registration page, the user may optionally register for an email club. The email club may consist of an electronic communication service that delivers to the user relevant updates about, for example, events, discounts, VIP tickets, promotional events, preferred pricing, and travel benefits. The user may enter registration data 510, which may include name, email address, phone number, zip code, and questions and/or comments the user may have about the service. The user may submit the registration data 510 by selecting the “Sign Me Up” button 520.

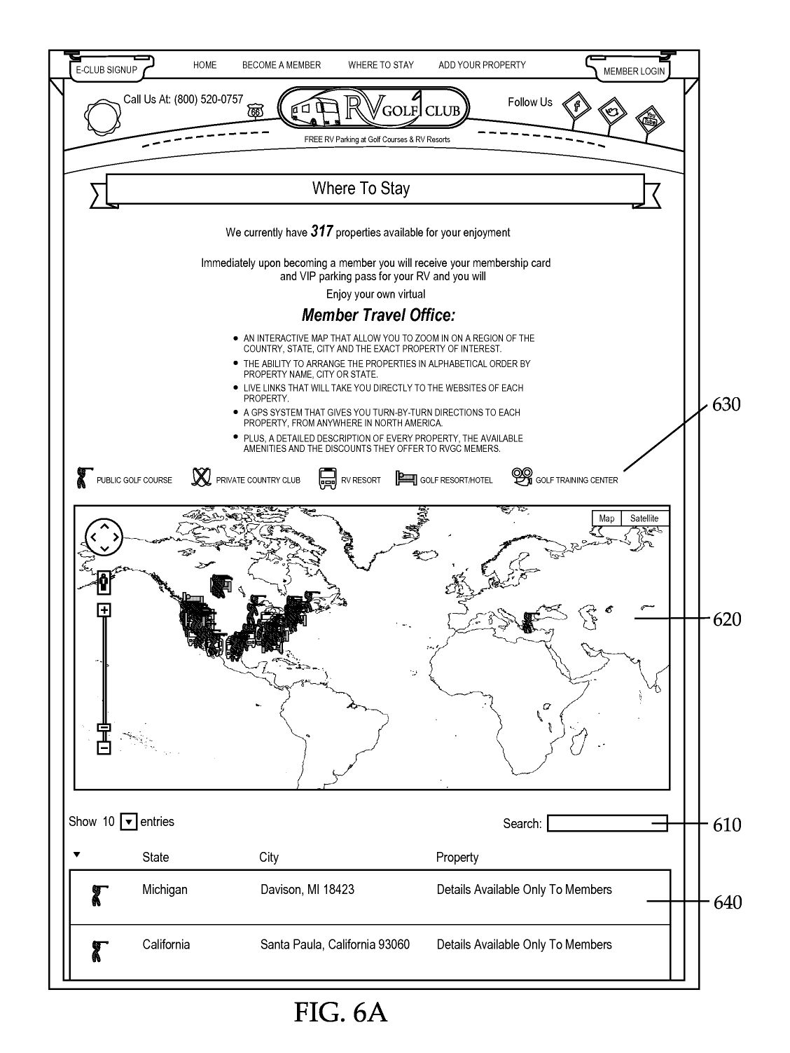

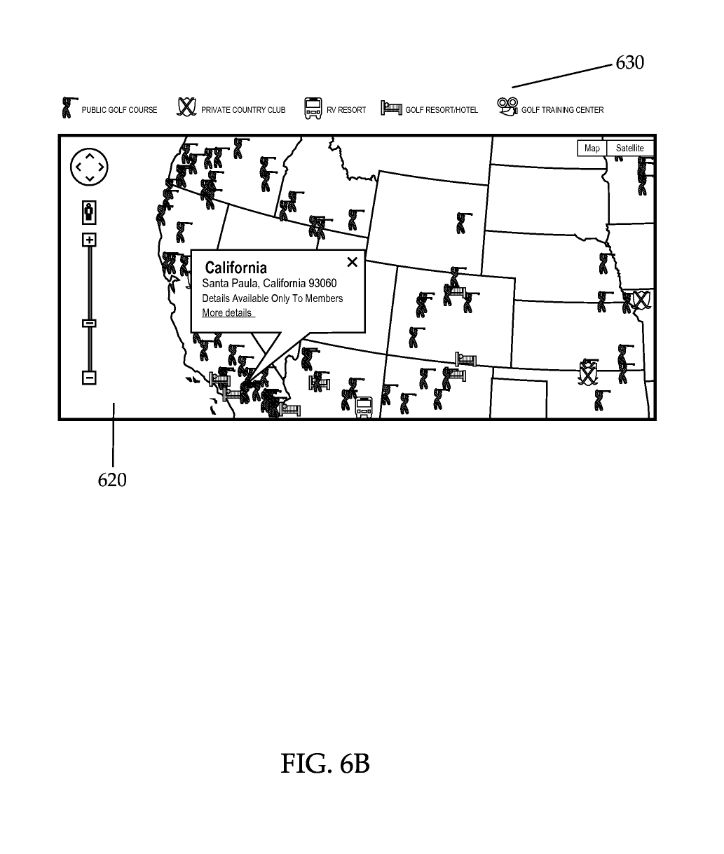

Referring now to FIG. 6A, illustrating an exemplary interface for an interactive property map, the user may search for participating properties with the RV golf association. The RV golf association administrator may or may not require the user to register before searching for properties and/or before viewing property-specific information. The user may search by, for example, zip code or city and state by entering search criteria in search box 610. Participating properties matching the search criteria may populate interactive map 620. Information about the properties may be displayed in property list 640 or by icon in interactive map 620, defined by map legend 630. Information may include location, property type, links to property website(s), directions to the property, available amenities, and discounts available to RV golf association members. The information in property list 640 may be sorted by user preference, including by location, type of property, or property name.

Referring now to FIG. 6B, which illustrates an exemplary interface for detailed interactive map 620. Interactive map 620 may allow the user to view participating properties, zoom in to a region of interest, and view information about specific properties. Textual information about a specific property may be viewable in popup window 650.

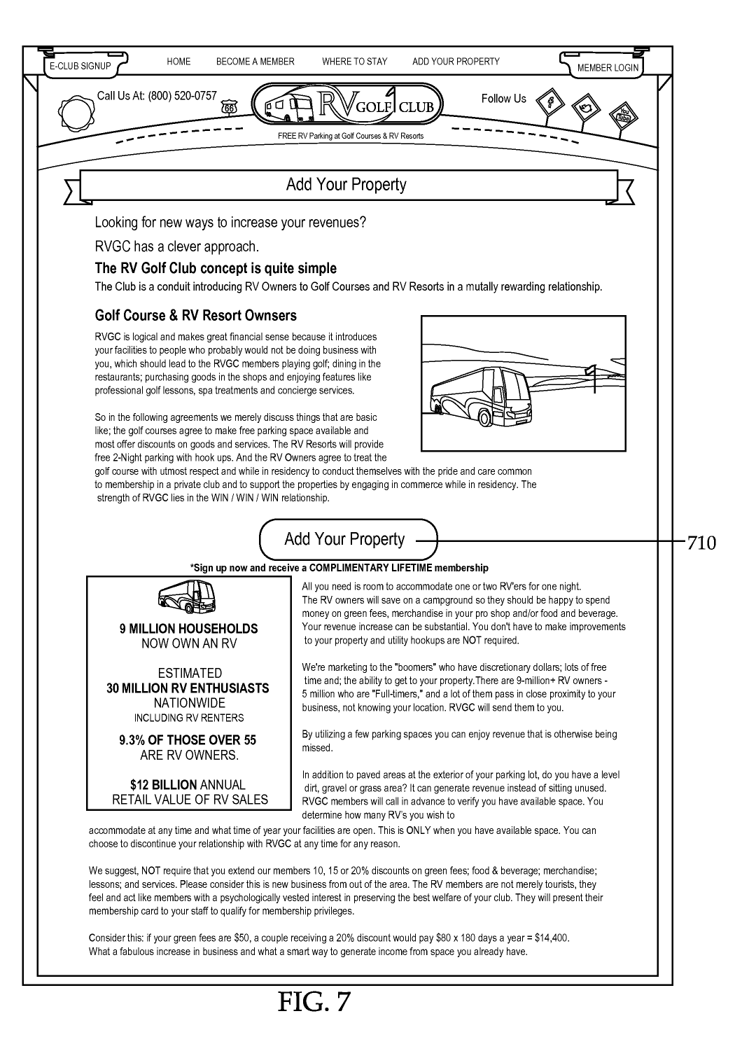

Referring now to FIG. 7, illustrating an exemplary interface for a property owner page, after the user (i.e., a property owner) clicks link 250 to begin the registration process, the user may be directed to an “Add Your Property” page. The membership page may include information regarding, for example, the benefits of membership with an RV golf association, requirements for membership, and suggested discounts or offers that property owners may offer to RV golf association members. The property owner, for example, may be a golf course or resort that offers a RV member a discount on green fees, carts, food, beverages, merchandise in retail shops, and services such as golf lessons or a massage in their health or fitness center. The property owner may offer other benefits and accommodations to the RV owner such as free or low cost parking, secure parking, towing, and hookups. The user may click on “Add Your Property” link 710 to begin the registration process.

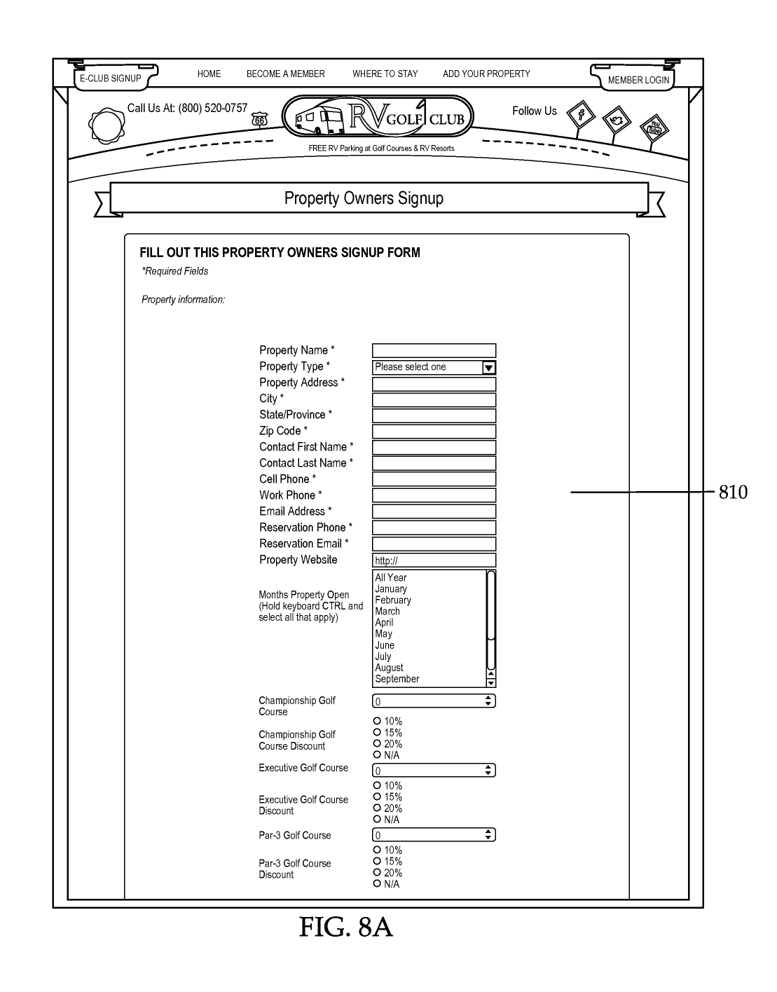

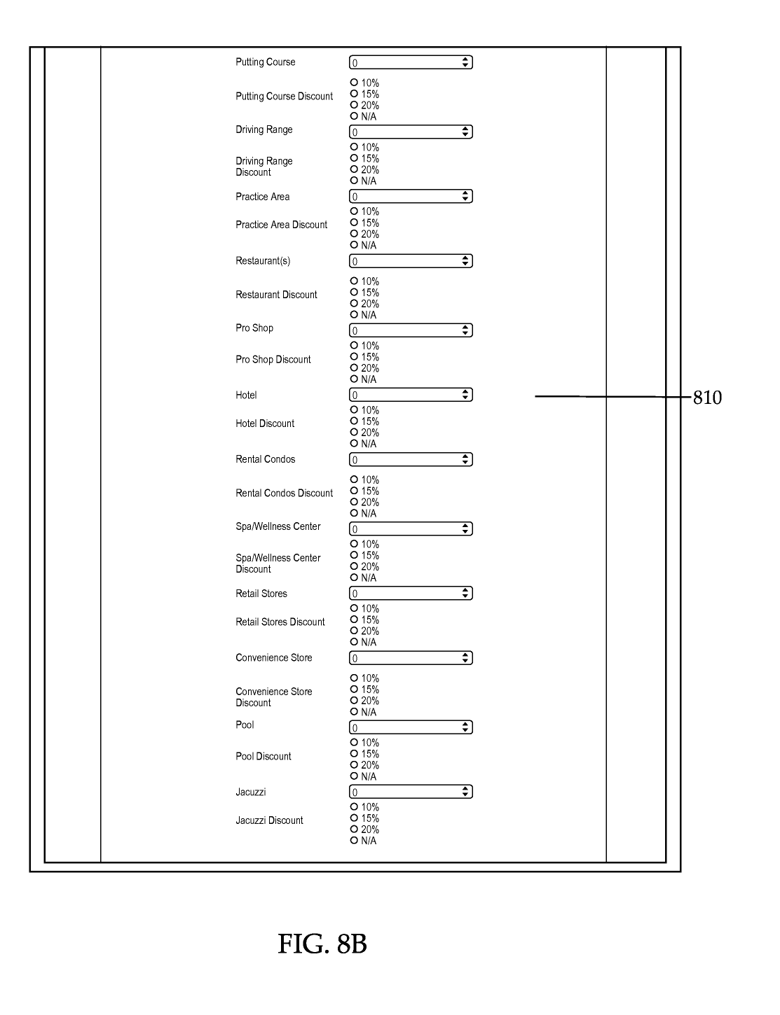

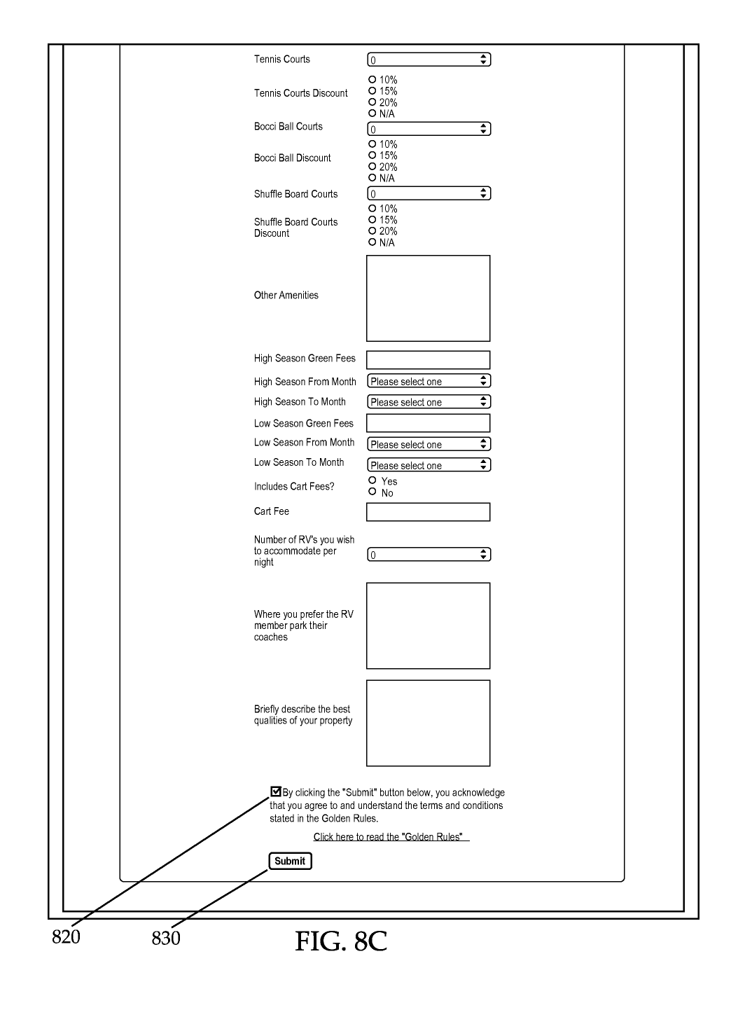

Referring now to FIG. 8A, illustrating a first screen of an exemplary interface for a property owner registration page, the user may provide registration data 810. Registration data may include, for example, user demographic information, user preferences, user contact information, property information, log-in information (i.e., user name and password), discounts that the user wishes to provide to the user (i.e., 10-20% off golf course greens fees, driving range fees, restaurant or pro shop purchases, and others), and other relevant information requested by an RV golf association administrator. FIGS. 8B and 8C show the second and third screens of the exemplary interface for the property owner registration page, including additional registration data that may be required from the user.

Referring now to FIG. 8C, the user may be required to agree to terms and conditions of membership with the RV golf association at box 820. The user may submit the registration data 810 by clicking “Submit” button 830. The user may then be prompted to enter payment information for the registration, if payment is required (not shown). Payment information may include, for example, credit or debit card information. The payment information may be processed via a third party payment processor.

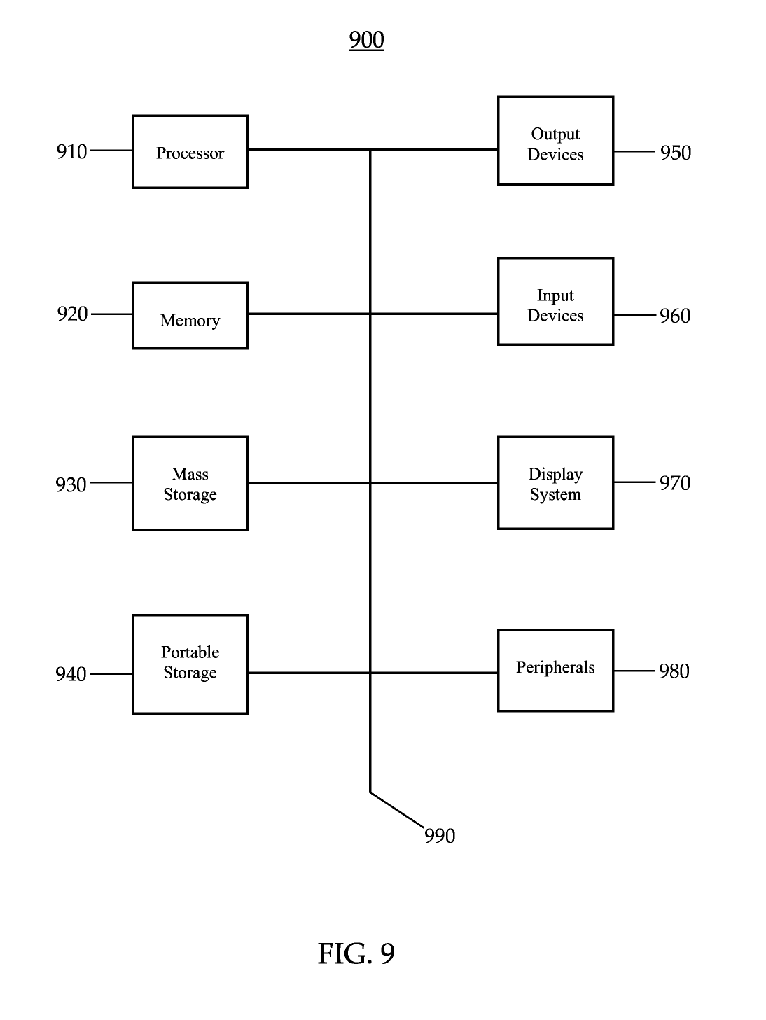

Referring now to FIG. 9, a computing system 900 is shown that may be used to implement an embodiment of the present invention. System 900 of FIG. 9 may be used to implement a computing device, network server, application server, and/or database operating in the context of the method of FIG. 1. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. The components, however, may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 may store the system software for implementing embodiments of the present invention for purposes of loading software into main memory 920.

Portable storage device 940 operates in conjunction with a portable nonvolatile storage medium, such as a floppy disk, compact disk or Digital video disc, to input and output data and code to and from the computer system 900 of FIG. 3. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 may receive textual and graphical information, and process the information for output to the display device.

Peripherals 980 may include any type of computer support device to add additional functionality to the computer system. For example, peripheral device(s) 980 may include a modem or a router.

The components contained in the computing system 900 of FIG. 9 are those typically found in computer systems that may be suitable for use with embodiments of the present invention and are intended to represent a broad category of such computer components that are well known in the art. Thus, the computing system 900 of FIG. 9 may be a personal computer, hand held computing device, tablet device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows Mobile, or iOS. The steps of the method of FIG. 1 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

What is claimed is:

1. A method for RV golf association registration, the method comprising:
generating a membership home page associated with an RV golf association on a computing device,
providing a link from the membership home page associated with a user type,
providing a link to an application type associated with the user type, and
receiving registration data associated with the user required for the application type.

2. The method of claim 1, wherein the user type includes an RV owner.

3. The method of claim 1, wherein the user type includes a property owner, wherein the property owner owns a property that includes at least one golf course.

4. The method of claim 1, wherein the application type includes an annual membership application.

5. The method of claim 1, wherein the application type includes a lifetime membership application.

6. The method of claim 2, wherein the registration data includes at least demographic information associated with a user, contact information, login information, and information associated with the RV owned by the user.

7. The method of claim 3, wherein the registration data includes at least demographic information associated with a user, contact information, login information, information associated with the property owned by the user, and at least one discount offered by the user to registered members of the RV golf association.

8. The method of claim 1, further comprising providing a link to complete an application for an email club.

9. The method of claim 8, wherein completing application for an email club includes providing at least an email address.

10. The method of claim 8, wherein the email club provides updates to registered users associated with the RV golf association.

11. The method of claim 1, further comprising providing a search feature for users to search for properties associated with the RV golf association.

12. The method of claim 11, wherein searching for properties includes entering search criteria.

13. The method of claim 12, wherein the search criteria includes at least one of a zip code, city, region, or state of interest.

14. The method of claim 1, further comprising requesting payment information required for the application type.

15. The method of 14, wherein the payment information includes credit or debit card information.

16. A system for RV golf association registration, the system comprising:
a server that generates a graphical interface, the server including:
memory; and
at least one processor; and
non-transitory instructions stored in the memory and executable by the processor to:
generate a membership home page associated with an RV golf association on a computing device,
provide a link from the membership home page associated with a user type,
provide a link to an application type associated with the user type, and
receive registration data associated with the user required for the application type; and
a plurality of computing devices that are communicatively coupled to the server over a communications network, the plurality of computing devices allowing for interaction with the server in real time by way of the graphical interface.
